(19) United States
(12) Patent Application Publication
(10) Pub. No.: US 2014/0340843 A1
(43) Pub. Date: Nov. 20, 2014

(54) ELECTRONIC DEVICE

(71) Applicant: Acer Incorporated, New Taipei City (TW)

(72) Inventors: Fang-Ying Huang, New Taipei City (TW); Ker-Wei Lin, New Taipei City (TW); Jung-Wei Tsao, New Taipei City (TW); Ren-Wei He, New Taipei City (TW)

(21) Appl. No.: 13/939,187

(22) Filed: Jul. 11, 2013

(30) Foreign Application Priority Data
May 16, 2013 (TW) 102209165

(51) Int. Cl. G06F 1/16

(52) U.S. Cl. CPC G06F 1/1675
USPC 361/679.55

(57) ABSTRACT

An electronic device includes a first body, a frame and a second body. The frame is pivoted with the first body and has a notch. The second body is pivoted with the frame and has a display surface. The frame is adapted to be rotated relatively to the first body, such that the second body is opened from or closed to the first body. The second body is adapted to rotate relatively to the frame to change the relative positions of the display surface and the first body. When a first portion of the second body is inlaid into the notch, a second portion of the second body is located out of the notch, such that the frame only partially surrounds the second body.

### CROSS-REFERENCE TO RELATED APPLICATION

This application claims the priority benefit of Taiwan application serial no. 102209165, filed on May 16, 2013. The entirety of the above-mentioned patent application is hereby incorporated by reference herein and made a part of this specification.

### BACKGROUND OF THE INVENTION

1. Field of the Invention

The present invention generally relates to an electronic device, in particular, to an electronic device having a display surface.

2. Description of Related Art

Since notebook computers have the same functions as common desktop computers, and with the light-thin design that allows users to carry conveniently, the notebook computers have become an indispensable tool for some users. As the price of the notebook computers falls constantly, some users even directly replace their desktop computer with a notebook computer.

Generally, the notebook computer has a host and a display module (for example, a liquid crystal display (LCD)) adapted to be opened from or closed to the host, and the display module may have a touch input function. To facilitate the user comfortably performing touch operations on the display, in some notebook computers, the display is not directly pivoted to the host but is connected to the host through a frame, such that the position of a display surface of the display can be changed while the display and the frame are rotating relative to each other, so as to reposition the display closer to the user. However, the frame may obstruct between the display surface of the display and the user when the display rotates to some positions, which causes inconvenience in utilization.

### SUMMARY OF THE INVENTION

Accordingly, the present invention is directed to an electronic device, in which a frame is prevented from obstructing between a display and a user.

In an embodiment of the invention, an electronic device includes a first body, a frame and a second body. The frame is pivoted with the first body and has a notch. The second body is pivoted with the frame and has a display surface. The frame is adapted to be rotated relatively to the first body, such that the second body is opened from or closed to the first body. The second body is adapted to rotate relatively to the frame to change the relative positions of the display surface and the first body. When a first portion of the second body is inlaid into the notch, a second portion of the second body is located out of the notch, such that the frame only partially surrounds the second body.

In view of the foregoing, the second body of the present invention is adapted to rotate relatively to the frame, such that a user can adjust the relative positions of the display surface and the first body accordingly. The frame is not a complete frame but a half frame which has a notch and may only partially surround the second body, therefore the frame is prevented from obstructing between the display surface of the second body and the user, so as to enhance the convenience in use of the electronic device.

Several exemplary embodiments accompanied with figures are described in detail below to further explain the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a three-dimensional diagram illustrating an electronic device according to an embodiment of the invention.

FIG. 2 is a three-dimensional diagram showing the second body of FIG. 1 is opened from the first body.

FIG. 3 is a three-dimensional diagram showing the second body of FIG. 2 leans against the first body.

FIG. 4 is a three-dimensional diagram showing the second body of FIG. 3 is suspended over the first body.

FIG. 5 is a three-dimensional diagram showing the back surface of the second body of FIG. 1 faces the first body.

FIG. 6 is a partial enlarged diagram of the first ear of the electronic device of FIG. 2.

FIG. 7 is a partial enlarged diagram of the second ear of the electronic device of FIG. 5.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

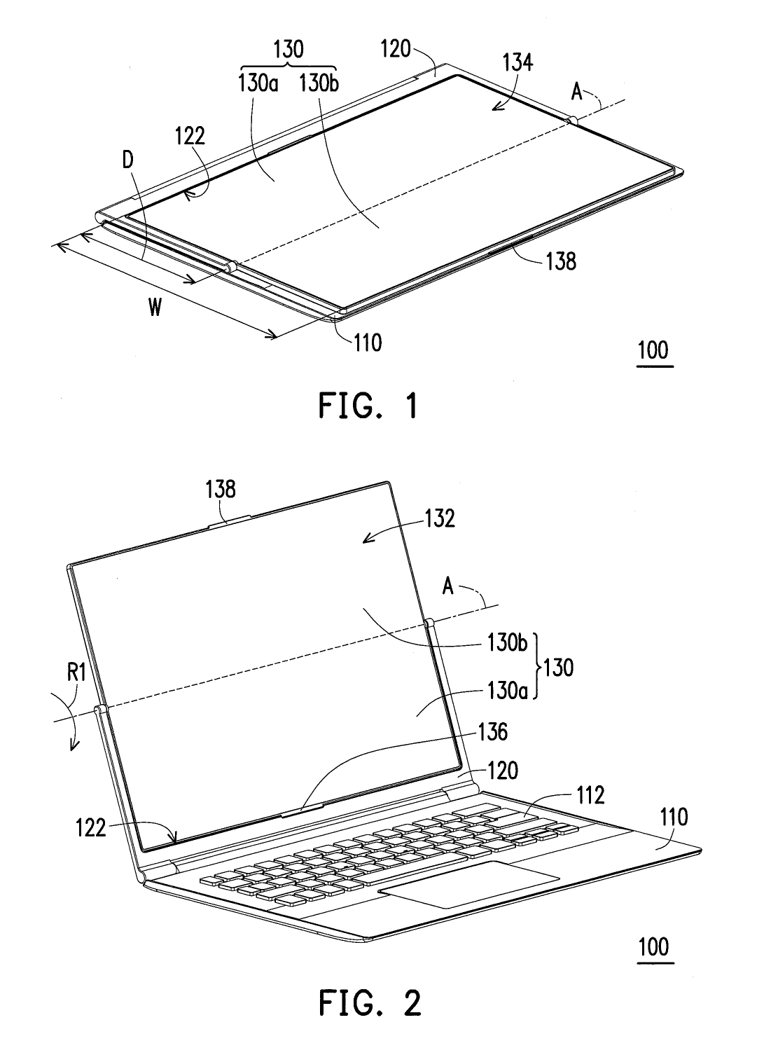

FIG. 1 is a three-dimensional view of an electronic device according to an embodiment of the invention. FIG. 2 is a three-dimensional diagram showing the second body of FIG. 1 is opened from the first body. Referring to FIG. 1 and FIG. 2, the electronic device 100 of the present embodiment is, for example, a notebook computer and includes a first body 110, a frame 120 and a second body 130. The first body 110 and the second body 130 are, for example, a host and a display of the notebook computer, respectively.

The frame 120 is pivoted with the first body 110 and has a notch 122. The second body 130 is pivoted with the frame 120 and has a display surface 132 and a back surface 134 opposite to each other. The frame 120 is adapted to rotate relatively to the first body 110, such that the second body 130 is opened from or closed to the first body 110. When the second body 130 is closed to the first body 110 as shown in FIG. 1 and a first portion 130a of the second body 130 is inlaid into the notch 122 of the frame 120, the display surface 132 of the second body 130 (labelled in FIG. 2) faces the first body 110 and is concealed, such that a user can store or carry the electronic device 100 conveniently. When the second body 130 is opened from the first body 110 as shown in FIG. 2 and a first portion 130a of the second body 130 is inlaid into the notch 122 of the frame 120, the user is convenient to watch the display surface 132 of the second body 130 and operate an input module (illustrated as a keyboard) of the first body 110.

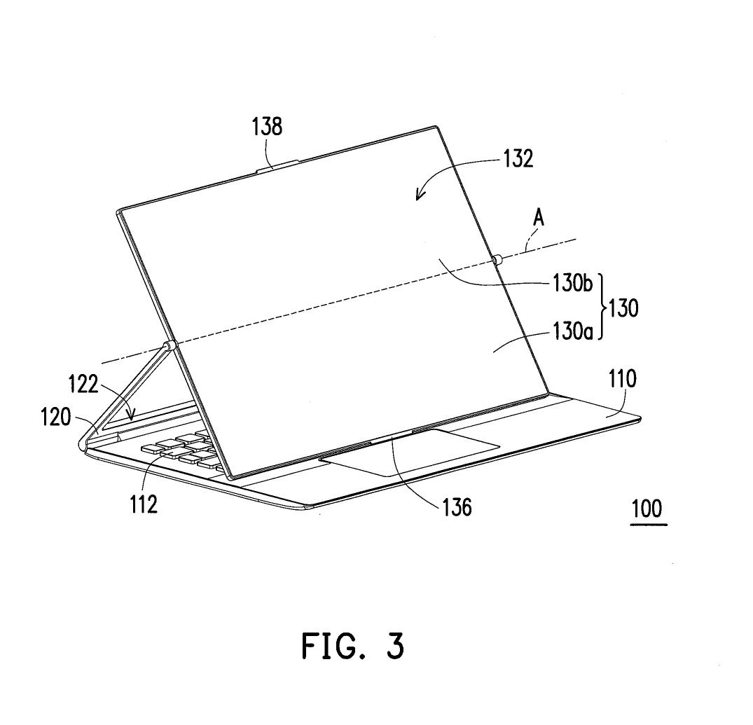

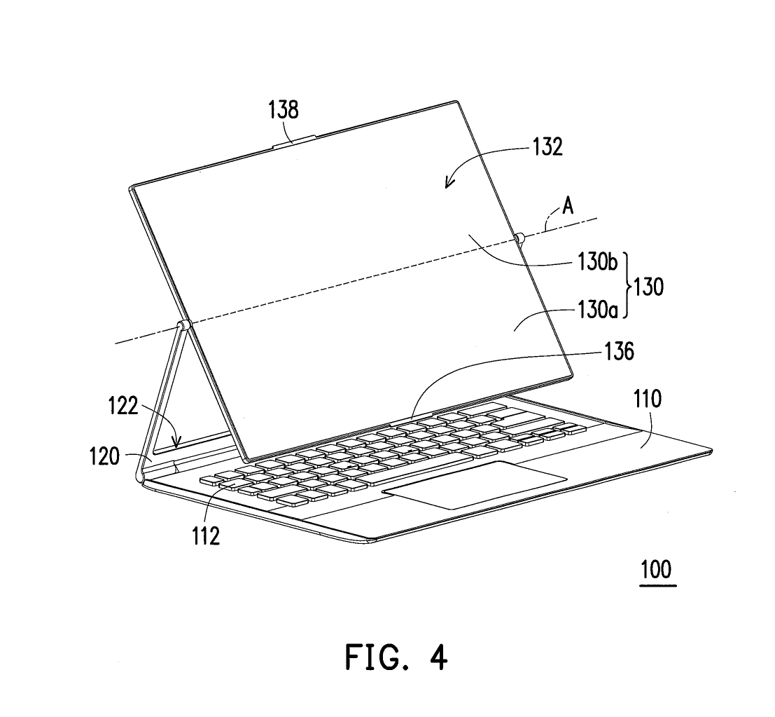

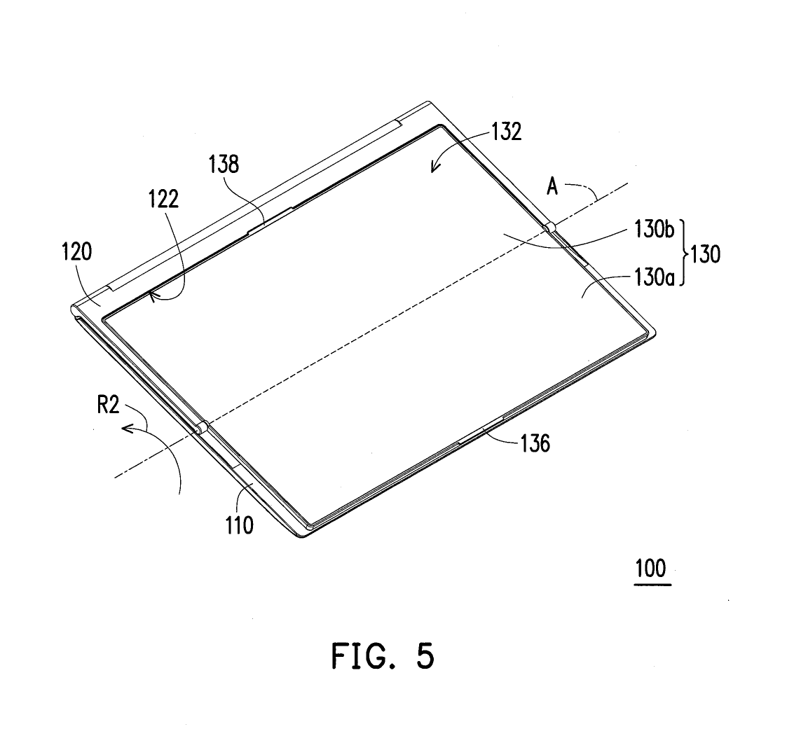

FIG. 3 is a three-dimensional diagram showing the second body of FIG. 2 leans against the first body. FIG. 4 is a three-dimensional diagram showing the second body of FIG. 3 is suspended over the first body. FIG. 5 is a three-dimensional diagram showing the back surface of the second body of FIG. 1 faces the first body. For the clearness of the figures, the first portion 130a and the second portion 130b of the second body 130 are separated with a dotted line in FIG. 1 to FIG. 5. When the second body 130 is opened from the first body 110 as shown in FIG. 2 and the first portion 130a of the second body 130 is inlaid into the notch 122 of the frame 120, the second body 130 is adapted to rotate relatively to the frame 120 to change the relative positions of the display surface 132 and the first body 110 as shown in FIG. 3, FIG. 4 and FIG. 5, such that the user can perform touch operation on the display surface 132 of the second body 130 conveniently.

Specifically, the second body 130 is adapted to rotate relatively to the frame 120, such that the first portion 130a of the second body 130 is opened from the frame 120 and away from the notch 122 of the frame 120. At this time, the frame 120 is adapted to rotate relatively to the first body 110, such that the first portion 130a of the second body 130 leans against the first body 110 as shown in FIG. 3 or is suspended over the first body 110 as shown in FIG. 4, such that the user can adjust the position of the display surface 132 of the second body 130 according to the actual requirement. In addition, the second body 130 is adapted to rotate relatively to the frame 120, such that the second portion 130b of the second body 130 is inlaid into the notch 122 of the frame 120 as shown in FIG. 5, and the second body 130 is adapted to be closed to the first body 110 by the rotating of the frame 120. At this time, the back surface 134 (labelled in FIG. 1) of the second body 130 faces the first body 110 and the display surface 132 of the second body 130 is exposed, such that the electronic device 100 is changed to a type similar to a tablet PC for the user to operate.

In the present embodiment, when the electronic device 100 is in a status shown in FIG. 1 or FIG. 2, the first portion 130a of the second body 130 is inlaid into the notch 122 of the frame 120, and the second portion 130b of the second body 130 is located out of the notch 122 of the frame 120, such that the frame 120 only partially surrounds the second body 130. Similarly, when the electronic device 100 is in a status shown in FIG. 5, the second portion 130b of the second body 130 is inlaid into the notch 122 of the frame 120, and the first portion 130a of the second body 130 is located out of the notch 122 of the frame 120, such that the frame 120 only partially surrounds the second body 130. In other words, the frame 120 is not a complete frame but a half frame which has the notch 122 and may only partially surround the second body 130. Thus, when the electronic device 100 is in a status shown in FIG. 3 or FIG. 4, the frame 120 is prevented from obstructing between the display surface 132 of the second body 130 and the user, so as to enhance the convenience in use of the electronic device.

In the embodiment, the frame 120 is, for example, in a U shape to form the notch 122 and to be shaped as a half frame. A depth D (labelled in FIG. 1) of the notch 122 of the frame 120 is smaller than a width W (labelled in FIG. 1) of the second body 130, the second body 130 is pivoted with the frame 120 along an axis A, and the axis A is located at an open end of the notch 122, such that the frame 120 only partially surrounds the first portion 130a or the second portion 130b of the second body 130.

In the present embodiment, when the second body 130 is inlaid into the frame 120 as shown in FIG. 1, FIG. 2 or FIG. 5, the second body 130 can be positioned by, for example, a magnetic attractive force generated between a magnet disposed in the frame 120 and the second body 130, or by an engaging structure formed on the frame 120, and the present invention does not limit thereto.

Referring to FIG. 2, in the embodiment, the first portion 130a of the second body 130 has a first ear 136, and the second portion 130b of the second body 130 has a second ear 138. When the first portion 130a of the second body 130 is inlaid into the notch 122 of the frame 120 as shown in FIG. 1 or FIG. 2, the first ear 136 of the first portion 130a and the frame 120 interfere with each other to stop the second body 130 from rotating along a first rotation direction R1 (labelled in FIG. 2) relatively to the frame 120. When the second portion 130b of the second body 130 is inlaid into the notch 122 of the frame 120 as shown in FIG. 5, the second ear 138 of the second portion 130b and the frame 120 interfere with each other to stop the second body 130 from rotating along a second rotation direction R2 (labelled in FIG. 5) contrary to the first rotation direction R1 respectively to the frame 120. By the interference formed between the first ear 136 and the frame 120 and the interference formed between the second ear 138 and the frame 120, a rotation range of the second body 130 relative to the frame 120 is limited, so as to prevent wires connected between the first body 110 and the second body 130 from breaking due to over rotating of the second body 130.

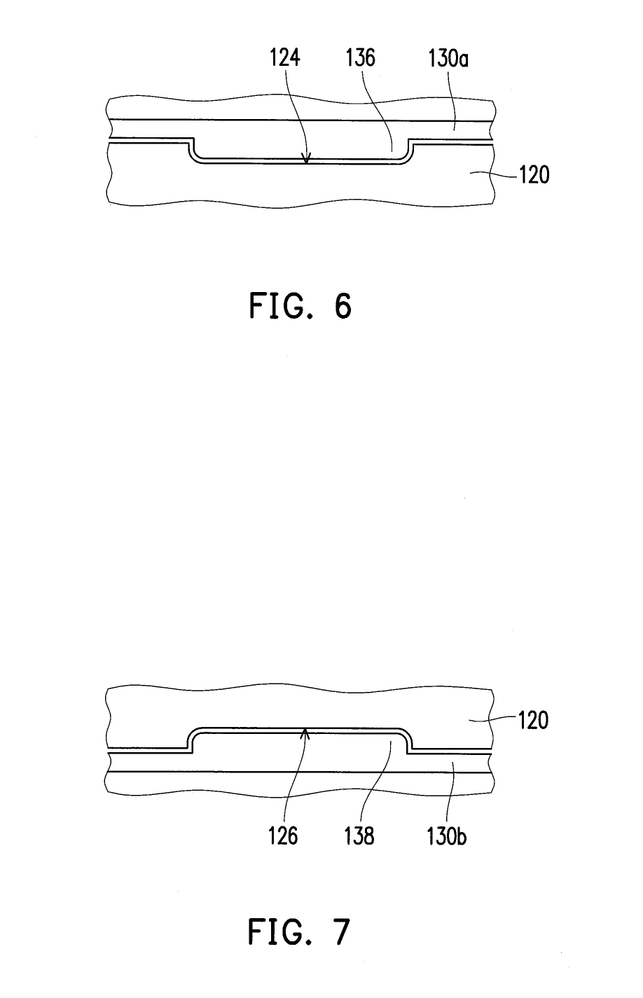

FIG. 6 is a partial enlarged diagram of the first ear of the electronic device of FIG. 2. FIG. 7 is a partial enlarged diagram of the second ear of the electronic device of FIG. 5. Referring to FIG. 6 and FIG. 7, the frame 120 of the present embodiment has a first concavity 124 and a second concavity 126. When the first portion 130a of the second body 130 is inlaid into the notch 122 of the frame 120 as shown in FIG. 1 or FIG. 2, the first ear 136 is located in the first concavity 124 of the frame 120, so as to prevent the interference formed between the first ear 136 and the frame 120 from causing the first portion 130a of the second body 130 unable to be inlaid into the notch 122 of the frame 120 successfully. Similarly, when the second portion 130b of the second body 130 is inlaid into the notch 122 of the frame 120 as shown in FIG. 5, the second ear 138 is located in the second concavity 126 of the frame 120 as shown in FIG. 7, so as to prevent the interference formed between the second ear 138 and the frame 120 from causing the second portion 130b of the second body 130 unable to be inlaid into the notch 122 of the frame 120 successfully.

In the present embodiment, the first ear 136 of the second body 130 not only can limit the rotation range of the second body 130 by the interference formed between itself and the frame 120 as above-mentioned, but also has a function of positioning the second body 130. Specifically, when the first portion 130a of the second body 130 is opened from the frame 120 as shown in FIG. 3 and leans against the first body 110, the first ear 136 of the second body 130 and the first body 110 interfere with each other to position the second body 130, so as to fix an inclined angle of the display surface 132 of the second body 130. The first body 110 has, for example, a suitable protruding structure for forming the above-mentioned interference with the first ear 136, and the present invention does not limit forms of the protruding structure.

In the present embodiment, the first ear 138 of the second body 130 not only can limit the rotation range of the second body 130 by the interference formed between itself and the frame 120 as above-mentioned, but also has a function of receiving a force from the user to drive the second body 130 to be opened from the first body 110. Specifically, when the second body 130 is closed to the first body 110 as shown in FIG. 1 and the first portion 130a of the second body 130 is inlaid into the notch 122 of the frame 120, the user can apply a force to the second ear 138 of the second body 130, such that the second ear 138 receives the force to drive the second body 130 to be opened from the first body 110 as shown in FIG. 2.

In summary, the second body of the present invention is adapted to rotate relatively to the frame, such that a user can adjust the relative positions of the display surface and the first body accordingly, so as to perform touch operation on the display surface conveniently. The frame is not shaped as a complete frame but as a half frame which has a notch and may only partially surround the second body, therefore the frame is prevented from obstructing between the display surface of the second body and the user, so as to enhance the convenience in use of the electronic device. In addition, the rotation range of the second body can be limited by the interference formed between the ear of the second body and the frame, so as to prevent wires connected between the first body and the second body from breaking due to over rotating of the second body.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic device, comprising:
a first body;
a frame, pivoted with the first body and having a notch; and
a second body, pivoted with the frame and having a display surface, wherein the frame is adapted to rotate relatively to the first body, such that the second body is opened from or closed to the first body,
wherein the second body is adapted to rotate relatively to the frame to change relative positions of the display surface and the first body, and when a first portion of the second body is inlaid into the notch, a second portion of the second body is located out of the notch, such that the frame only partially surrounds the second body.

2. The electronic device according to claim 1, wherein when the second body is closed to the first body and the first portion is inlaid into the notch, the display surface faces the first body and is concealed.

3. The electronic device according to claim 1, wherein when the second body is opened from the first body and the first portion is inlaid into the notch, the second body is adapted to rotate relatively to the frame, such that the first portion is opened from the frame and away from the notch.

4. The electronic device according to claim 1, wherein when the first portion is opened from the frame and away from the notch, the frame is adapted to rotate relatively to the first body, such that the first portion leans against the first body or is suspended over the first body.

5. The electronic device according to claim 1, wherein the second body is adapted to rotate relatively to the frame, such that the second portion is inlaid into the notch, and when the second portion is inlaid into the notch, the first portion is located out of the notch, such that the frame only partially surrounds the second body.

6. The electronic device according to claim 1, wherein the second body has a back surface opposite to the display surface, and when the second body is closed to the first body and the second portion is inlaid into the notch, the back surface faces the first body and the display surface is exposed.

7. The electronic device according to claim 1, wherein the frame is in a U shape to form the notch.

8. The electronic device according to claim 1, wherein a depth of the notch is smaller than a width of the second body.

9. The electronic device according to claim 1, wherein the second body is pivoted with the frame along an axis, and the axis is located at an open end of the notch.

10. The electronic device according to claim 1, wherein the first portion has a first ear, the second portion has a second ear, when the first portion is inlaid into the notch, the first ear and the frame interfere with each other to stop the second body from rotating along a first rotation direction relatively to the frame, and when the second portion is inlaid into the notch, the second ear and the frame interfere with each other to stop the second body from rotating along a second rotation direction contrary to the first rotation direction relatively to the frame.

11. The electronic device according to claim 10, wherein the frame has a first concavity and a second concavity, when the first portion is inlaid into the notch, the first ear is located in the first concavity, and when the second portion is inlaid into the notch, the second ear is located in the second concavity.

12. The electronic device according to claim 10, wherein when the first portion is opened from the frame and leans against the first body, the first ear and the first body interfere with each other to position the second body.

13. The electronic device according to claim 10, wherein when the second body is closed to the first body and the first portion is inlaid into the notch, the second ear is adapted to receive a force to drive the second body to be opened from the first body.
